(19) United States
(12) Patent Application Publication
(10) Pub. No.: US 2007/0259252 A1
(43) Pub. Date: Nov. 8, 2007

(54) Ceramic cathode material for solid oxide fuel cells and gas separation systems

(75) Inventor: Rasit Koc, St. Louis, MO (US)

Correspondence Address: Jeff Myers;Office of Research Development & Administration, Southern Illinois University Carbondale MC 4709, Carbondale, IL, 62901, US

(73) Assignee: Board of Trustees of Southern Illinois Univesity, Carbondale, IL (US)

(21) Appl. No.: 11/796,664

(22) Filed: Apr. 27, 2007

Related U.S. Application Data
(60) Provisional application No. 60/797,131, filed on May 2, 2006.

(51) Int. Cl. H01M 4/86

(52) U.S. Cl. 429/40

(57) ABSTRACT

A ceramic composition for use in cathode and interconnect materials in solid oxide fuel cells and other electrolytic gas separation systems, such as oxygen separation systems, comprising Lanthanum doped with either Calcium, Strontium, or Barium, in combination with Coboltite, Chromite and Ferrite Oxides.

### CROSS-REFERENCE TO RELATED APPLICATIONS

This application claims the priority filing date of provisional application No. 60/797131, which is hereby fully incorporated herein by reference.

### FIELD OF INVENTION

This invention relates to a ceramic composition, and more specifically to materials used for the cathode and interconnect in solid oxide fuel cells and in electrolytic gas separation applications.

### BACKGROUND OF THE INVENTION

### Fuel Cell Composition

A solid oxide fuel cell is an electromechanical device that continuously converts chemical energy into electrical energy by exploiting the natural affinity of oxygen and hydrogen to react. By controlling the means by which such a reaction occurs and directing the reaction through a device it is possible to harvest the electrical energy given off by the reaction.

Fuel cells are fairly simple devices that contain no moving parts and are comprised of four basic components: cathode, anode, electrolyte and interconnect. The concept of the fuel cell has been around since 1839, when William Grove developed the first fuel cell, called a gaseous voltaic battery. In this first fuel cell, platinum was used as the material for the electrodes, which are the cathode and the anode. The fuel cell will remain in operation as long as the fuel and the oxidant are supplied. There is a great deal of interest in one type of fuel cell, the solid oxide fuel cell, because of being capable of converting a wide variety of fuels with high efficiency.

### Fuel Cell Material Composition

The electrolyte is a material that must possess high ionic conductivity with no electronic conductivity. This is a requirement to allow the oxygen ions to migrate through the electrolyte material. Yttria Stabilized Zirconium (YSZ) is currently a promising electrolyte material. The usual thickness of the electrolyte material in a solid oxide fuel cell is less than 40 microns.

The anode acts as the fuel electrode. One of the materials of choice for the anode is a Nickel-YSZ composite.

The interconnect acts as an electrical contact to the cathode, and has the important task of protecting the anode from the damaging effects of the atmosphere. Electronic conductivity in the interconnect should be 100% with no porosity in the material, to prevent the mixing of the fuel and oxygen in the cell. Interconnect material must be stable in oxidizing and reducing atmospheres under the operating condition of the fuel cell. One of the materials of choice for the interconnect is LaCrO.sub.3, usually doped with Sr, Ca and Co to help improve the electrical conductivity. Other interconnect materials exist, based on the alloys Fe—Cr—Ni, TiN—TiC—Ni—Ni.sub.3Al and Mn—Co—O for the solid oxide fuel cells operating at intermediate temperature (600-800 degrees C.).

The cathode material has stringent requirements that must be met for usage in the solid oxide fuel cell. The cathode material consists of a material that is porous, permitting migration of oxygen molecules to reach the electrolyte. Currently, one of the materials of choice for the cathode is LaMnO.sub.3, which is a p-type perovskite material. Usually this material is doped with Sr or other rare earth material to tailor transport properties of the cathode. The cathode material in the fuel cell has to act, not only as a catalyst for the dissociation of oxygen, but as an electrode as well. Applications are being found for pervoskite-type oxides as cathodes because of their high electrical conductivities and catalytic activity.

There are several key shortcomings in solid oxide fuel cells that are in dire need of improvement today. First, improvement is needed in the conductivity of the cathode and interconnect, and in the electrical insulation of the electrolyte. Second, the chemical and structural stability of the interconnect, and the tightness of the interconnect material, need improvement. Third, each of these four materials must have similar thermal expansion characteristics, so that stress fractures do not develop as the fuel cell faces increasing temperature during fabrication or operation. Fourth, a reduction in the operating temperature of the fuel cell is important, through improvements in the electrolyte and cathode materials. Lowering the operating temperature increases the potential for rapid market entrance. Finally, lowering the cost of the materials and their fabrication is necessary for increasing adoption of fuel cell technology in the transportation and other industries. Whenever a change is made to one of these materials, one must consider the effect it has on the interaction with the other materials in the fuel cell.

### Current Fuel Cell Materials

The solid oxide fuel cell demands materials that possess chemical stability and electrical conductivity, as well as similar thermal expansion constants. Currently there are a variety of different materials that are being used as cathode materials for the solid oxide fuel cell. (La,Sr)(Co,Fe)O.sub.3, (La,Sr)(Cr,Mn)O.sub.3 and (La,Ca)(Cr,Co)O.sub.3 compositions of materials have been studied for use as cathode materials. The findings have confirmed that the perovskite-type ABO.sub.3 compositions, which contain two types of transition metal ions on the B site, are always more desirable than those with only one type of transition metal ion. Studies have confirmed that (La,Sr)(Co,Fe)O.sub.3 material has the highest oxygen permeability, which is more than an order of magnitude greater than that of stabilized zirconia. This is because the Sr on the A site lattice of the material acts as an acceptor and can enhance the formation of oxygen vacancies. Calcium is also used as an acceptor in these materials for the same effect.

Investigation has been conducted using (La, Sr)(Cr,Mn)O.sub.3 in developing interconnect and cathode materials for solid oxide fuel cells. Sintering studies have been conducted in air at temperatures below 1500 degrees C. These studies have shown significant improvement in the densifications with the substitution of 50 mol % for chromium. A 95% theoretical density was achieved with the substitution of 70 mol % Mn for Chromium. It is suggested Calcium can be more effective acceptor for tailoring the properties of (La)(Cr,Mn)O.sub.3 to meet the exacting requirements of fuel cell producers.

(La,Sr)MnO₃ is generally one of the popular choices for the cathode due to its good chemical stability with the other materials within the cell. Yttria Stabilized Zirconium is often times used as an electrolyte material and the (La,Sr)MnO₃ has very good chemical stability between the two materials. The development of these new materials leads to the lowering of the operational temperature of the Solid Oxide Fuel Cell (“SOFC”), thus lowering the production cost by allowing alternative and more cost effective materials to be used for the other components of the fuel cell.

Acceptor-doped lanthanum manganites have been used for cathode material in many SOFC due to the stability of this material in oxidizing atmospheres. The acceptor doped lanthanum manganite material has shown to have sufficient electrical conductivity at 1000° C. Acceptor doped lanthanum manganite has been one of the choices for cathode material as well because of close thermal expansion constants to that of the currently used YSZ electrolyte.

Studies have been done to compare the differences in LaCrO₃, LaFeO₃, and LaMnO₃ with promising results by doping the materials with various transition metals to improve the sinterability and the electronic conductivity of the samples in high temperature conditions. Alternative materials are continuously being investigated as potential replacement materials for the cathode in the SOFC. LaCrO₃ is being doped with calcium to lower its resistivity and mainly as a sintering aid. It has been found that the substitution of Co for Cr into LaCrO₃ imparts good thermal expansion matching characteristics. This substitution allows for LaCrO₃ to sinter in air at temperatures below 1400° C. as well as improving the electrical conductivity at 1000° C. LaFeO₃ is proving to be an interesting alternative to the lanthanum manganite material that is currently being used. Doped LaFeO₃ possesses high electrical conductivity and the rate of reaction with YSZ is reduced when compared to LaMnO₃.

However, there are still shortcomings with these materials, and although research has shown approaches to individual problems, these sometimes have undesirable effects. The cathode material of strontium-doped LaMnO₃ is proven to be less stable than LaCrO₃ in reducing conditions and begins to lose oxygen and experience substantial decrease in conductivity. In fuel gas at 1000° C. strontium-doped LaMnO₃ dissociates into La₂O₃, SrMnO₃, and MnO and becomes structurally unsound. Lanthanum Chromites (LaCrO₃) have been considered for cathode and interconnect materials on solid oxide fuel cells because of their high electrical conductivity and high temperature stability in both reducing and oxidizing conditions, but studies have shown that LaCrO₃ does not sinter in air because of chromium volatilization. The process of substituting chromium by other transition metals which include (Sr, Ca, Mn, and Co) have shown to considerably enhance the sintering process. The doping of the material with various transition metals has shown to dramatically increase the sinterability as well as improving other critical properties of the cathode material.

LaCrO₃ exhibits a thermally-activated high temperature due to p-type small polaron hopping among the B-site cations. This material proves to be stable to high temperatures over a wide range of temperatures with a wide range of oxygen partial pressures as well. LaCoO₃ conducts by the same mechanism as LaCrO₃ but with a significantly greater conductivity.

Thus, there is a need for a material which has all the characteristics of high electronic conductivity, high oxygen permeability, excellent chemical stability at high temperatures, excellent material tightness, desirable thermal expansion characteristics, low operating temperature, and which can be easily manufactured by sintering in conditions acceptable with other cell components.

### SUMMARY OF THE INVENTION

The present invention solves the shortcomings of the prior art. The new acceptor doped (La)(Co,Cr,Fe)O.sub.3 material for use in solid oxide fuel cell cathode and interconnect applications exhibits excellent properties for oxygen permeability, conductivity, thermal expansion, chemical stability at high temperatures, material tightness, low operating temperature, and ease of manufacturability as compared to prior art materials. The present invention incorporates the desired properties of the end members into a new composition:
LaCoO.sub.3—high electronic conductivity and ease of manufacture because of sinterability;
LaCrO.sub.3—chemical stability towards reduction; and
LaFeO.sub.3—high electronic conductivity and thermal expansion characteristics and compatibility with other fuel cell components currently in use in SOFC applications.

The present invention is unique because of the relative ease of manufacturing. The method for manufacturing the cathode material is a fairly simple operation. The materials are capable of being scaled up to increase the quantity of material that is being developed. The benefit of being able to produce on a large scale is a profound impact on the solid oxide fuel cell developers. The present invention is more stable in reducing conditions than LaFeO.sub.3, LaMnO.sub.3, and LaCoO.sub.3. These materials can be incorporated with other potential materials under investigation such as Mn—Co—O spinels and TiN, TiC, Ni, and Ni.sub.3Al, especially for use as an interconnect material, or combination cathode and interconnect. The ease of manufacturing of the material, such as from being able to sinter at ambient atmospheric contents and pressures without the use of inert environments without oxidation, allows for the production cost of the fuel cell to be dramatically lowered.

### BRIEF DESCRIPTION OF THE DRAWINGS

FIG. 1 is an X-Ray Diffraction plot of the composition La_{0.69}Ca_{0.3}Fe_{0.6}Cr_{0.2}Co_{0.2}O₃.

FIG. 2 is a plot of Electrical Conductivity as a function of temperature of the composition La_{0.69}Ca_{0.3}Fe_{0.6}Cr_{0.2}Co_{0.2}O₃.

### DETAILED DESCRIPTION OF THE PREFERRED EMBODIMENT

The preferred manner of making one embodiment of the composition is presented for small batches in a laboratory. Any suitable method of manufacture may be employed for the present invention. Other methods of creation and embodiments of this compound are possible and included in the conception of the invention. The preferred embodiment presented is not intended to limit the invention, but only to illustrate one possible composition and method of manufacture and testing. The relative content of each of the components can be adjusted to favor the attributes of the invention, such as stability or sinterability or conductivity. The best embodiment represents what is perceived to be the optimal combination to address the widest number of desirable attributes with the fewest undesirable properties.

The materials that were used in the process of making the preferred embodiment in the present invention consisted of La and Ca, Sr and Ba carbonates, and Cr, Co and Fe nitrates. Each of the materials that were tested were divided into 15-25 gram samples for evaluation. Initial weights of the materials were measured. Two samples of each of the starting materials were investigated and an average weight loss was calculated for the individual starting materials.

The material that was investigated under this research were all for the (La.sub. 1-m,B.sub. m)(Fe.sub.x,Co.sub.y,Cr.sub.z)O3, where 1>m>0 and x+y+z=1.0 and x,y,z each not equal to 0 composition. The material was developed using batching calculations to determine the proper amounts of starting materials that are necessary for the development of these compounds.

Samples were made into 20 gram portions of material. Once the initial batching calculation has been performed one can begin the process of mixing the material to construct the desired new cathode material. The process that is used for the batching of the material is the Polymer Precursor method similar to that of Pechini. Prior to beginning the process it is necessary for one to have the proper equipment to perform the material batching. The equipment necessary for the performance of this process include: 1000 ml beaker, glass stirring rods, metal scoop/spatula, balance, material trays, citric acid in powder form and ethylene glycol. Each of the starting materials are carefully weighed on the balance and poured into the 1000 ml beaker. Once all of the materials have been placed in the beaker, citric acid and ethylene glycol can be added to the mixture. It is necessary for one to place the material under an operational fume hood during the heating cycle. The beaker is placed on a hot plate that is turned on to medium heat (95° C.).

The mixture is heated with stirring occasionally with the glass stirring rods. The material will turn brown to black in color with the application of heat to the mixture. Throughout the process stirring is necessary and the use of small amounts of distilled water can be used to rinse the material from the sides of the beaker. Once the heating cycle is completed the material is in a brown to black powder form. The prepared material can be placed in a crucible for calcination.

The developed cathode materials were heated to a temperature of 800° C. for a period of 8 hours. The material is removed from the calcination crucible and placed into plastic mixing vials. Along with the material being placed in the vial the addition of 2 plastic spheres are placed in the vial as well. The spheres are used to agitate the material throughout the mixing cycle. The jar is sealed with a plastic lid with a seal to prevent any material from escaping during the milling cycle. Each of the materials that were developed went through a milling cycle of 15 minutes. A small amount of the newly developed cathode material is placed in a sample holder for X-ray diffraction analysis. The developed cathode materials were studied at room temperature using powder X-ray diffraction. The difractometer was operated with a CuKa target with a Ni filter. The X-ray diffraction analysis showed single phase materials formation with no additional phases. In order to investigate the fabribicability of the developed materials, sintering studies were conducted.

A pellet press and die are used to perform the procedure of pressing the powder into pellet format. The die used in the pellet pressing process forms a pellet that is approximately 1.25 cm in diameter and with a thickness that ranges from 0.5 cm to over 1.5 cm depending on the amount of material that is applied to the die prior to pressing.

A mill/mixer must be utilized to blend the PVA binder with the developed powders. The powder is placed into plastic vials where 8-10 drops of PVA binder are added to the developed powder along with 2-3 plastic spheres. The addition of the spheres to the vials helps to promote even mixture throughout the cycle. The PVA binder is added to the powder to allow for the material to bond together while pressure is being applied in the die. The milling cycle for the developed powder and the PVA binder is a cycle that ranges from 5 to 10 minutes in length. Upon completion of the mixing cycle the powder can be measured out into 5-6 gram samples for insertion into the die. Die lubricant is sprayed into the die walls prior to pouring the material into the die. Once the material is placed in the die the spacer is added and the pressing can begin. The die is placed in the press and pressure is applied to reach an amount of six tons (12,000 lbs). Pressure is left on the material for 5 minutes to allow even pressure distribution throughout the sample. The die pressure can be released and the newly formed pellet can be extracted from the die by using a plastic collar and the application of a small amount to pressure. This process was repeated for the different material compositions that were used in the cathode material development process.

The developed cathode materials were sintered at various temperatures that ranged from 1200-1400° C. It is necessary to determine the proper sintering temperatures of the compounds to eliminate the possibility of partial melting of the material. The newly developed materials were placed in high temperature crucibles for the sintering process.

Using the programming feature on the controller a program is written to develop a temperature ramp cycle for the developed material. Each of the developed materials were setup to ramp at a rate of 4° C. per minute and hold at the sintering temperature for a period of 10 hours. Upon completion of the sintering process the microstructure development of the material is completed. Scanning Electron Microscopy Analysis was used to determine the microstructure of the sintered materials. These investigations demonstrated that the fabricability of the invented materials meet the exacting requirements of solid oxide fuel cells.

Each of the samples were coated with four coats of platinum ink for electrical conductivity measurements. The ink was allowed to dry between each coating. Once the final coating of platinum ink had dried the pellets need to be placed into a furnace for the platinum coating to cure. The samples were heated to 600° C. for a period of 4 hours. Once the samples have cured the conductivity measurements and analysis can begin.

A four-wire, two-point Kelvin technique AC method was employed for the electrical conductivity measurements. The apparatus that was used for the electrical conductivity measurements consists of a tube furnace capable of 1700° C. The tube furnace is fitted with a tube that is capable of withstanding high temperatures. Attached to the end on the tube is an apparatus designed for holding the specimen during the cycling of the furnace. The apparatus consists for four platinum wires encased in mullite material; two of each are contacted to electrodes that contact the coated platinum coating that is painted on the ends of the specimen. Pressure can be applied to squeeze the electrodes together to ensure good contact between the sample and the electrodes. The four lead wires of the apparatus are connected to an AC resistance bridge.

The resistance was measured across the material as a function of temperature. The target point that was investigated for the developed cathode materials is 800° C. The temperature was ramped up to 800° C. and held at that temperature until the resistance measurement stabilized. In most cases the resistance stabilized in a period of 4-6 hours. The temperature was ramped down in 100° C. increments and resistance measurements were taken at each of these temperatures.

Knowing the resistance and the dimensions of the material one can calculate the resistivity of the material. The data that was collected from the samples was analyzed and plots were derived.

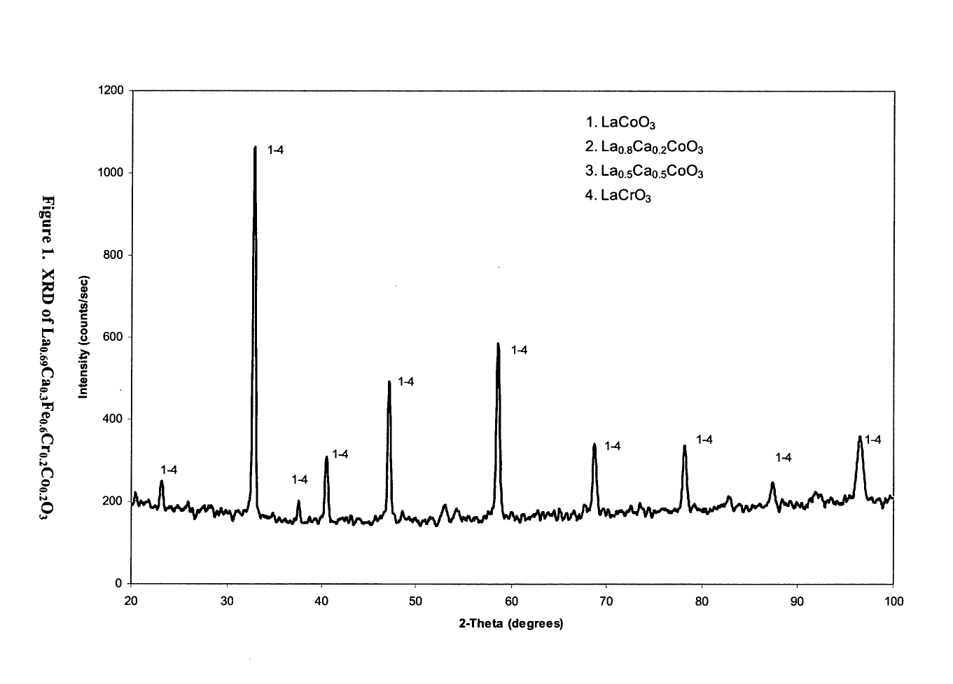

Illustrated in FIG. 1 is the x-ray diffraction pattern for developed cathode material La_{0.69}Ca_{0.3}Fe_{0.6}Cr_{0.2}Co_{0.2}O₃. The data that is illustrated in FIG. 1 shows the XRD pattern for the lanthanum ferrite material that was doped on the B-side with chromium and cobalt in small amounts. Upon doing investigation of the XRD patterns and using card file data there were four compositions of materials that proved to be close matches to the diffraction pattern. The potential matches for the XRD pattern in FIG. 1 were LaCoO₃ (Card # 25-1060), La_{0.8}Ca_{0.2}CoO₃ (Card # 36-1389), La_{0.5}Ca_{0.5}CoO₃ (Card# 36-1390), and LaCrO₃ (Card# 24-1016). The present invention shows a high level of material matched due to the addition of the Cr and Co dopants to the composition.

The cathode material research each of the developed materials were sintered in air at 1400° C. or below. Sintering at a temperature that is too high causes damage to the physical structure of the pellet.

Currently there is little data in the literature about the transport mechanism during the sintering process. Through the works of Koc and Kaga investigation of the sintering behavior of (La,Ca)(Cr,Co)O3 was studied using high temperature DSC, results from this study conclude that La.sub.0.79Ca.sub.0.20Cr.sub.0.9Co.sub.0.1O.sub.3 can be sintered at temperatures below 1400° C. The study found that the formation of a transient liquid phase and a persistence reaction occurred at temperatures below 1400 C. The research of Koc and Kaga concluded that the composition of the transient phase is dependant on the amount of Co and Ca substitution.

Due to the experimental process, bulk densities of the developed material reached 95%. The process of doping the lanthanum ferrite compound with Co and Cr has proven to improve the sinterability of the material. Through the usage of experimental tools the proper sintering temperatures were determined for the developed cathode materials. The present invention was sintered at 1300° C. with a ramp rate of 4° C. per minute for 10 hours.

The hardness testing results conclude that the lanthanum ferrite material that is doped with Co and Cr proves to have a slightly higher hardness. This can be potentially due to the sintered density of the samples containing Cr, Fe, and Co. Upon observation of material La.sub.0.69Ca.sub.0.3Fe.sub.0.6Co.sub.0.4Osub.3 the hardness of that particular material is significantly lower than material La.sub.0.69Ca.sub.0.3Fe.sub.0.6Co.sub.0.4Osub.3 and material La.sub.0.69Ca.sub.0.3Fe.sub.0.6Cr.sub.0.2Co.sub.0.2O.sub.3. Upon studying the developed materials the addition of Cr to the B-side adds hardness to the material. Material La.sub.0.69Ca.sub.0.3Fe.sub.0.6Cr.sub.0.2Co.sub.0.2O.sub.3 that was doped with Co and Cr had hardness values that very closely resembled that of a material that was doped Cr on the B-site. Each of the materials were pressed into pellet format using the same pressures, thus the conclusion has been made the addition of Cr to the composition increases the hardness of the material.

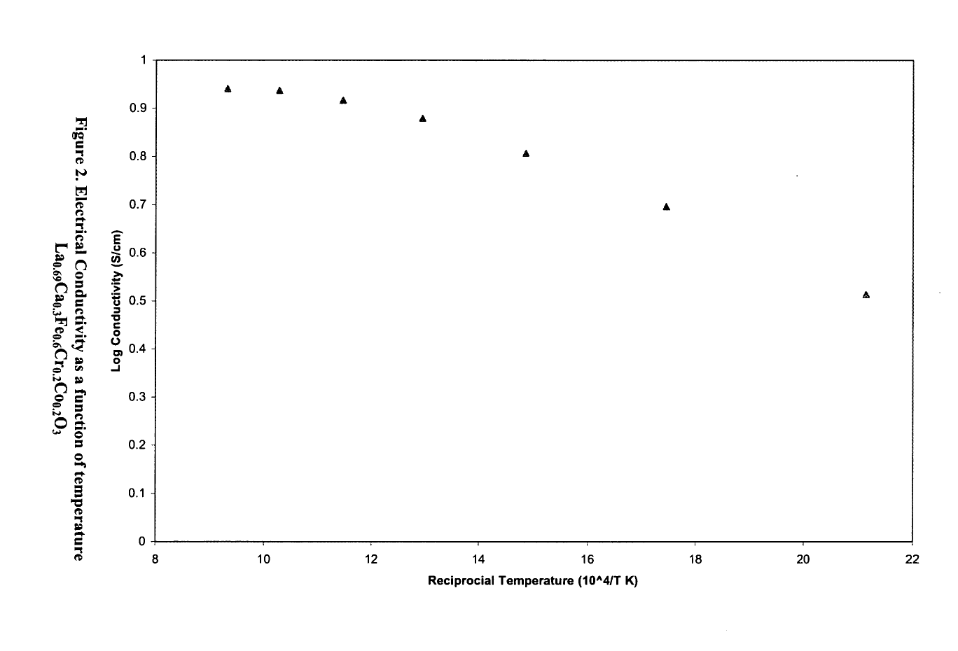

The AC electrical conductivity measurements were done using the two probe four wire conductivity testing apparatus. As mentioned previously the four wire setup used platinum wires as attachment points to the electrodes. Platinum wires are used in this application due to the low electrical resistance through the wire. The low electrical resistance of the platinum wire allows for the researcher to provide more accurate conductivity measurements. The four wire setup is linked to the AC resistance bridge for the recording process of the resistances through the material. Prior to performing the conductivity testing the pellets that were in cylindrical format were cut using a Leco diamond cutting wheel. The cutting of each of the developed materials yielded two rectangular pellets. It is desired to have the smallest contact surface area permissible for the perforation of the conductivity test. Each of the samples to be tested it was necessary to have a conductive coating applied to the ends of the rectangular bars. This conductive coating consisted of platinum ink that was painted on the ends of the cut rectangular bar pellets. Once the platinum ink is painted onto the ends of the sample pellets it is necessary for the coating to be cured. Pellets were placed in a box furnace for a period of 4 hours at a temperature of 600° C. Recording of resistances were measured across a temperature that ranges for 200-800° C. A period of time was allowed for the stabilization of the resistance prior to recording a resistance reading. FIG. 2 shows log(s) conductivity as a function of reciprocal temperature*(10,000). It is shown through graphical analysis that the conductivity of each of the samples increases with temperature.

Through the usage of a variety of experimental procedures the developed cathode material has proven to be a candidate cathode material for use in low temperature SOFC. The experimental methods used included XRD, SEM, TEM, Hardness testing, and electrical conductivity testing. Evaluation and observation of each of these experimental methods leads one to conclude that the developed materials have proven to be a potential replacement for current cathode materials for use in low temperature SOFC and other gas separation applications, such as oxygen separation systems.

XRD diffraction patterns for the developed material proved it to be a single phase pervoskite material. In comparing the XRD patterns with each other the patterns proved to be quite similar in structure. SEM and TEM imaging allowed for the investigation of the grain structure and particle size of the developed powders at the given magnifications. The SEM proved the material to have uniformly developed grain boundaries with slight levels of porosity. TEM imaging has shown the effects of dopants on the B-side in relationship to particle size. Through the usage of TEM imaging it is possible that the substitution of Co on the B-side allows for the reduction of particle sized in the developed powder.

The conductivity data that was collected for the developed material has proven to be applicable to the cathode materials for the SOFC. Measured electrical conductivities are quite similar to materials that are currently being used as cathode materials in the SOFC. The activation energies for the developed material are similar to the data described in the literature for currently used materials.

The process for the development and fabrication of the cathode material in the present invention has proven to be fairly simple without a large degree of complexity. The developed material is capable of being scaled up for larger operations and studies of the material. The goal of developing a low cost simple to manufacture SOFC cathode material has been reached. Due to the material's chemical makeup, the compatibility of the cathode material with the other components of the SOFC should be applicable without complication.

The particular composition disclosed is meant to be illustrative only as one example of the invention. This example is not limiting as to the scope of invention, which is to be given the full breadth of the claims appended and any and all equivalents thereof.

I claim:

1. A ceramic material having a pseudo-perovskite structure and a composition comprising (La)(Co.sub.x, Cr.sub.y, Fe.sub.z)(O.sub.3) where x+y+z=1.0 and x, y, z are each non-zero.

2. The composition in claim 1 further comprising doping the La with at least one ingredient selected from the group consisting of Ca, Sr, and Ba.

3. The composition in claim 1 further comprising the content of La to be 0.70 or less, which satisfies the formula (La.sub.m)(Co.sub.x, Cr.sub.y, Fe.sub.z)(O.sub.3) where m is less than or equal to 0.70, x+y+z=1.0 and x, y, z are each non-zero.

4. The composition in claim 2 further comprising the content of La to be 0.70 or less, which satisfies the formula (La.sub.m, Bsub.(1-m))(Co.sub.x, Cr.sub.y, Fe.sub.z)(O.sub.3) where m is less than or equal to 0.70, x+y+z=1.0 and x, y, z are each non-zero, and B is at least one ingredient selected from the group consisting of Ca, Sr, and Ba.

5. The composition in claim 1 further comprising at least one ingredient selected from the list consisting of the carbide TiC and nitride TiN.

6. A ceramic material for use as an electrode and interconnect in solid oxide fuel cells and electrolytic gas separation applications having a composition which satisfies the formula (La.sub.m, B.sub.n)(Co.sub.x, Cr.sub.y, Fe.sub.z)(O.sub.3), where m is equal to 0.69, B is at least one ingredient selected from the group consisting of Ca, Sr, and Ba, n is a value in the range of 0.10 to 0.40, x+y+z=1.0 and x, y, z are each non-zero.

7. A ceramic material for use as a cathode and interconnect in solid oxide fuel cells and electrolytic gas separation applications having a composition which satisfies the formula (La.sub.m, B.sub.n)(Co.sub.x, Cr.sub.y, Fe.sub.z)(O.sub.3) where m is equal to 0.69, B is at least one ingredient selected from the group consisting of Ca, Sr, and Ba, n is equal to 0.30, x+y+z=1.0 and x, y, z are each non-zero, and further comprising at least one ingredient selected from the list consisting of the carbide TiC and nitride TiN.
